(19) United States
(12) Patent Application Publication
(10) Pub. No.: US 2023/0095568 A1
(43) Pub. Date: Mar. 30, 2023

(54) OBJECT TRACKING DEVICE, OBJECT TRACKING METHOD, AND PROGRAM

(71) Applicant: NTT Communications Corporation, Tokyo (JP)

(72) Inventor: Shuhei TARASHIMA, Tokyo (JP)

(21) Appl. No.: 18/062,823

(22) Filed: Dec. 7, 2022

Related U.S. Application Data
(63) Continuation of application No. PCT/JP2021/021075, filed on Jun. 2, 2021.

(30) Foreign Application Priority Data
Jun. 16, 2020 (JP) 2020-103804

(51) Int. Cl. G06T 7/246; G06T 7/66

(52) U.S. Cl. CPC G06T 7/246; G06T 7/66; G06T 2207/30241; G06T 2207/10016

(57) ABSTRACT

An object tracking device according to an embodiment obtains trajectories that indicate tracks of target objects in an input video. The object tracking device has parallel processing hardware, and this parallel processing hardware: extracts primary points and secondary information for restoring a field of a target object captured in an image frame at a time t included in the video; selects, from among the extracted primary points, a primary point having the closest distance to a predicted primary point of the target object predicted from the trajectories obtained by a time t−1; and, when the distance is smaller than a first threshold determined from secondary information corresponding to the selected primary point, associates the selected primary point and the secondary information corresponding to the selected primary point, with a trajectory corresponding to the predicted primary point of the target object.

### CROSS-REFERENCE TO RELATED APPLICATIONS

The present application is a continuation filed under 35 U.S.C. 111 (a) claiming the benefit under 35 U.S.C. 120 and 365 (c) of PCT International Application No. PCT/JP2021/021075, filed on Jun. 2, 2021, and designating the U.S., which is based on and claims priority to Japanese Patent Application No. 2020-103804, filed on Jun. 16, 2020. The entire contents of PCT International Application No. PCT/JP2021/021075 and Japanese Patent Application No. 2020-103804 are incorporated herein by reference.

### BACKGROUND OF THE INVENTION

### 1. Field of the Invention

The present invention relates to an object tracking device, an object tracking method, and a program.

### 2. Description of the Related Art

A set of techniques for tracking an unspecified number of objects (for example, people, vehicles, etc.) captured in an input video is known as “multi-object tracking” (and also referred to simply as “object tracking techniques”), and plays an essential and key role in applications for bringing smart social systems to reality, including video surveillance, automatic driving, sports analysis, and so forth. In such applications, each individual object's track (hereinafter also referred to as “trajectory”) is obtained as an output of object tracking techniques, and can be directly applied to the counting of objects subject to tracking, obstacle detection, calculation of moving distance/moving speed, and so forth. Also, object tracking techniques are widely used in pre-processing before extracting higher-level information pertaining to, for example, behavior understanding and anomaly detection for tracking target objects, and thus are a set of techniques with extremely high industrial applicability.

Generally speaking, algorithms for object tracking techniques are often built on a framework called “tracking-by-detection.” According to this framework, the algorithm's processes are roughly divided into a detection process and a tracking process. First, in the detection process, objects are detected from each image frame constituting a video. Subsequently, by tracking techniques, the location, appearance, movement, and so forth of each object are identified for use as cues, and object tracking takes place by associating detection results in which the same object is captured, between image frames.

In the detection process described above, objects are detected from each image frame by using known object detection techniques. One well-known object detection technique is called “YOLOv3,” which uses a neural network model to detect objects in images (see, for example, Non-Patent Document 1).

Furthermore, the methods disclosed in Non-Patent Document 2 and Non-Patent Document 3, for example, are also known methods of object tracking based on the “tracking-by-detection” framework. Non-Patent Document 2 assumes that, among the image frames that constitute a video, ones with short intervals between image frames capture the same object in close locations, and thus an object is tracked by evaluating the degree of overlap of object fields obtained by applying known object detection techniques between neighboring image frames. In Non-Patent Document 3, to improve the tracking performance with respect to an object that changes its location significantly during the tracking process, first, a motion model is built from the trajectory built up to the previous image frame, and, using this motion model, the object's location in the next image frame is predicted, and then the degree of overlap of object fields between image frames is evaluated. Note that an object field refers to an image field of an object detected by an object detection technique, and is often defined in the form of, for example, a rectangle that encloses an object in a fitting manner, a segmentation that captures an object in pixel units, and so forth.

### CITATION LIST

### Non-Patent Document

[Non-Patent Document 1] J. Redmon and A. Farhadi. YOLOv3: An incremental improvement. In arXiv preprint arXiv: 1804.02767, 2018.

[Non-Patent Document 2] E. Bochinski, V. Eiselein, and T. Sikora. High-speed tracking-by-detection without using image information. In AVSS Workshop, 2017.

[Non-Patent Document 3] A. Bewley, Z. Ge, L. Ott, F. Ramos, and B. Uperoft. Simple online and realtime tracking. In ICIP, 2016.

### SUMMARY OF THE INVENTION

### Technical Problem

However, in object tracking techniques based on the tracking-by-detection framework, including the object tracking techniques disclosed in Non-Patent Document 2 and Non-Patent Document 3 above, it is necessary to transfer data regarding object fields between a CPU (Central Processing Unit) memory and a GPU (Graphics Processing Unit) memory, which makes the overall processing throughput low.

For example, in known object detection techniques including the object detection technique disclosed in above Non-Patent Document 1, key processes (one example being the convolutional neural network forward propagation process) are carried out by a processor specialized for parallel calculation such as a GPU, and the output of this processor is post-processed in a CPU and output as an object detection result. Therefore, object detection techniques based on the tracking-by-detection framework requires data transfer between a CPU memory and a GPU memory, which reduces the overall process throughput. Here, the post-process is called “NMS” (Non-Maximum Suppression), and typically carried out by “greedily” removing the object fields that overlap each other significantly, with the goal of eliminating the redundancy of object fields.

Note that, while it is possible to perform all processes that relate to object detection techniques in a CPU, since the key processes include, for example, the convolutional neural network forward propagation process and the like, the processing speed typically decreases significantly. Furthermore, while it is also possible to perform all processes that relate to object detection techniques in a GPU, this is not efficient because the post-process, namely NMS, is an algorithm based on a greedy algorithm and is unsuitable for parallel processing.

Also, in the tracking process, in which detection results obtained by using object detection techniques are input, it is common to formulate and solve the problem of associating the same object between image frames as a 0-1 integer programming problem. Although an exact solution of a 0-1 integer programming problem can be found by enumerating candidate solutions, this method cannot be solved in a realistic period of time because the number of candidate solutions increases explosively as the number of variables increases. For this reason, the branch-and-bound method is often used as a method for finding an optimal solution by narrowing down the candidate solutions, but its algorithm is serial and not suitable for parallel processing in a GPU and the like. Therefore, when at least part of the detection process based on object detection techniques is executed by a GPU or the like, it is then necessary to transfer data between a CPU memory and a GPU memory.

An embodiment of the present invention has been made in view of the above, and aims at realizing high-throughput multi-object tracking.

### Solution to Problem

In order to achieve the above aim, the object tracking device according to one embodiment of the present invention provides an object tracking device for obtaining trajectories that indicate tracks of target objects in an input video. The object tracking device has parallel processing hardware, and this parallel processing hardware: extracts primary points and secondary information for restoring a field of a target object captured in an image frame at a time t included in the video; selects, from among the extracted primary points, a primary point having the closest distance to a predicted primary point of the target object predicted from the trajectories obtained by a time t−1; and, when the distance is smaller than a first threshold determined from secondary information corresponding to the selected primary point, associates the selected primary point and the secondary information corresponding to the selected primary point, with a trajectory corresponding to the predicted primary point of the target object.

### Advantageous Effects of the Invention

It is therefore possible to realize multi-object tracking with high throughput.

### BRIEF DESCRIPTION OF THE DRAWINGS

Other objects, features and advantages of the present invention will become more apparent from the following detailed description when read in conjunction with the accompanying drawings:

FIG. 1 is a diagram for explaining an example of object tracking according to related art;

FIG. 2 is a diagram for explaining an example of object tracking by an object tracking device according to the present embodiment;

FIG. 3 is a diagram showing an example functional configuration of the object tracking device according to the present embodiment;

FIG. 4 is a diagram showing an example detailed functional configuration of a trajectory set updating unit according to the present embodiment;

FIG. 5 is a flowchart showing an example object tracking process according to the present embodiment;

FIG. 6 is a flowchart showing an example trajectory set updating process according to the present embodiment; and

FIG. 7 is a diagram showing an example hardware configuration of the object tracking device according to the present embodiment.

### DETAILED DESCRIPTION OF THE PREFERRED EMBODIMENTS

Now, an embodiment of the present invention will be described below. In the present embodiment below, an object detector to detect objects from each individual image frame that constitutes a video is given, but on the other hand no prior knowledge or model is given regarding the movement of these objects. Based on this premise, an object tracking device 10 that automatically extracts the trajectories of objects captured in an input video will be described. In doing so, the object tracking device 10 according to the present embodiment uses the primary point of each object and secondary information for restoring the object field of each object, as will be described later, so that the object tracking device 10 is able to perform the entire object tracking process efficiently in parallel processing hardware such as a GPU. Furthermore, because there is thus no need to transfer data between the CPU memory and the GPU memory, high-throughput multi-object tracking can be realized.

Note that, although training data for learning the models for detecting objects such as people and vehicles by using still images as input is widely available, on the other hand, little data is available that includes such objects' moment-by-moment movement; accordingly, the above-noted conditioning may be considered natural. Also, “throughput” means the processing capability per unit time, and refers to, for example, the number of image frames that can be processed per unit time.

<Comparison with Related Techniques>

First, differences between the object tracking by the object tracking device 10 according to the present embodiment and object tracking based on related techniques will be briefly described.

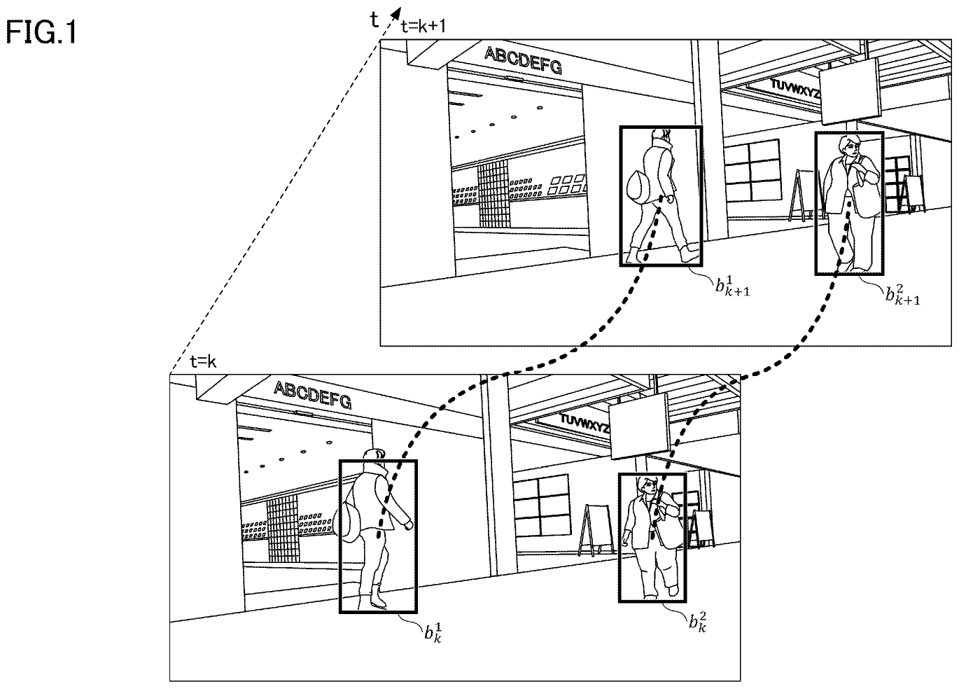

For example, in the object tracking based on related techniques described in above Non-Patent Document 2 and Non-Patent Document 3, object fields, which encapsulate objects that are captured in individual image frames constituting a video, are associated with one another, on a per object basis, thus tracking each object. For example, as shown in FIG. 1, assume that an object field bₖ¹ of one object 1 and an object field bₖ² of another object 2 are obtained from an image frame of a time t=k, and that an object field bₖ₊₁¹ of object 1 and object field bₖ₊₁² of object 2 are obtained from an image frame of a time t=k+1. At this time, if object field bₖ¹ and object field bₖ₊₁¹ are object fields of the same object, these object field bₖ¹ and object field bₖ₊₁¹ are associated with one another. Similarly, if object field bₖ² and object field bₖ₊₁² are object fields of the same object, these object field bₖ² and object field bₖ₊₁² are associated with one another. In this way, in object tracking based on related techniques, objects captured in a video are tracked by associating the object fields encapsulating every same object with one another. That is, in object tracking based on related techniques, first, object fields are detected by using object detection techniques such as that described in above Non-Patent Document 1, and then, by using these object fields as inputs in the tracking process, the object fields of each same object are associated with one another and trajectories are generated.

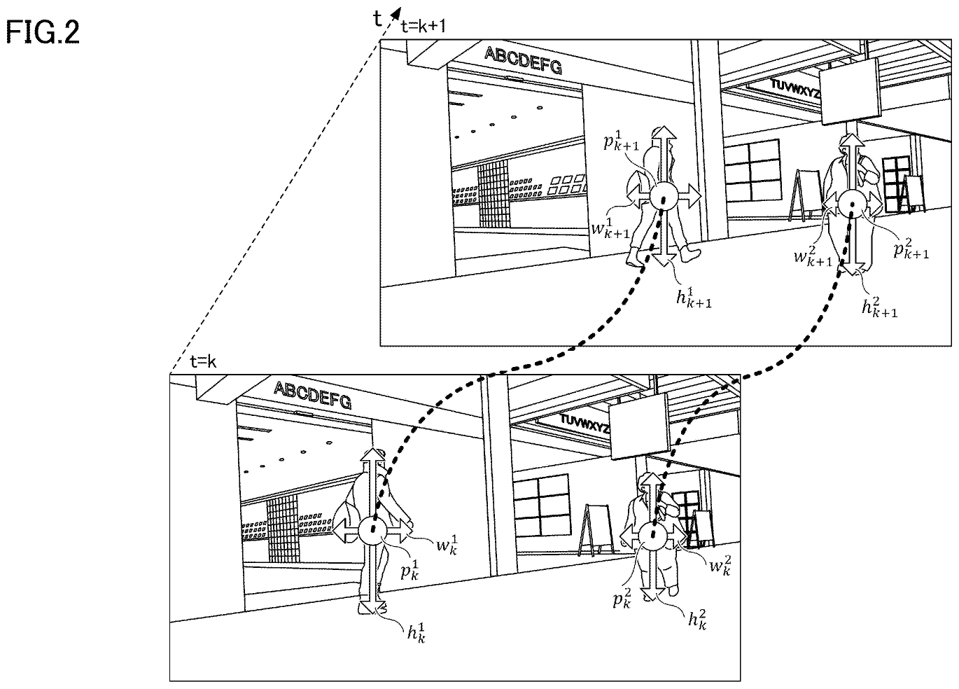

Now, in contrast with the above, the object tracking device 10 of the present embodiment uses the primary points of objects captured in each individual image frame constituting part of an input video and secondary information for restoring the object fields of these objects, as inputs in the tracking process, to associate the primary point and secondary information of each same object and generate trajectories. For example, using the center of an object field as a primary point and the width and height of the object field as secondary information, assume that, as shown in FIG. 2, a primary point pₖ¹ and secondary information (wₖ¹, hₖ¹) of one object 1 and a primary point pₖ² and secondary information (wₖ², hₖ²) of another object 2 are obtained from the image frame at time t=k, and that a primary point pₖ₊₁¹ and secondary information (wₖ₊¹, hₖ₊₁¹) of one object 1 and a primary point pₖ₊₁² and secondary information (wₖ₊₁², hₖ₊₁²) of another object 2 are obtained from the image frame at time t=k+1. At this time, if object 1 in the image frame of time t=k and object 1 in the image frame of time t=k+1 are the same object, then (pₖ¹, wₖ¹, hₖ¹) and (pₖ₊₁¹, wₖ₊₁¹, hₖ₊₁¹) are associated with each other (that is, sets of primary points and secondary information are associated with one another). Similarly, if object 2 in the image frame of time t=k and object 2 in the image frame of time t=k+1 are the same object, then (pₖ², wₖ², hₖ²) and (pₖ₊₁², wₖ₊₁², hₖ₊₁²) are associated with one another. In this way, the object tracking device 10 according to the present embodiment realizes the tracking of objects captured in a video by associating the primary points and secondary information of each same object. That is, the object tracking device 10 according to the present embodiment uses the primary points and secondary information of objects in each individual image frame as inputs in the tracking process, and associates the primary points and secondary information (or object fields restored from the primary points and secondary information) of each same object with one another to generate trajectories. By this means, as will be described later, it is possible to realize multi-object tracking with high throughput. Note that the primary points and secondary information are interchangeable with object fields.

<Definitions of Symbols>

Now, the symbols used in the present embodiment will be defined below.

Assume that an input video given to the object tracking device 10 is divided into a set of K image frames {I₁, I₂, . . . , I_{K}}. Iₖ is the image frame at time t=k.

Also, the output of the object tracking device 10 is a set of trajectories T={T₁, T₂, . . . , Tₙ, . . . }. Each trajectory Tₙ is the trajectory of an object n (in other words, information representing the track of object n), represented as:

Tₙ={bₖ_{₁}_{ⁿ},bₖ_{₂}_{ⁿ}, . . . }

where bₖ is the object field of object n at time t=k.

In the present embodiment described below, object field bₖ is a field represented by a rectangle to enclose an object in an image frame in a fitting manner. Although a rectangle may be defined in a variety of ways, the present embodiment employs the formula b=(p, w, h) or b=(x, y, w, h), where p=(x, y)ϵR² is the center of the rectangle, and wϵR and hϵR are the width and the height of the rectangle, respectively. Note that R stands for all real numbers.

However, the object field is by no means limited to being a field represented by a rectangle, and, for example, the object field may be defined by segmentation, in which each pixel constituting the image frame indicates whether or not the object is captured therein. Also, for example, the object field may be defined by a rectangular parallelepiped that encloses the object three-dimensionally, in a fitting manner.

Note that “enclosing in a fitting manner” does not necessarily mean surrounding the object in a strictly fitting manner. For example, part of the object may stick out of the object field, or, conversely, there may be some margin between the object and the boundaries of the object field. For example, fields that can be represented as a rectangle to enclose an object in a fitting manner typically include the bounding box of the object, and such other fields.

Also, as mentioned earlier, primary points and secondary information are interchangeable with object fields, so that a trajectory may be formed with a primary point and secondary information, instead of an object field. That is, bₖ may be the primary point and secondary information of object n at time t=k. In the present embodiment which will be described below, a case will be mainly described in which a primary point and secondary information are the elements to constitute a trajectory.

<Functional Configuration of the Object Tracking Device 10>

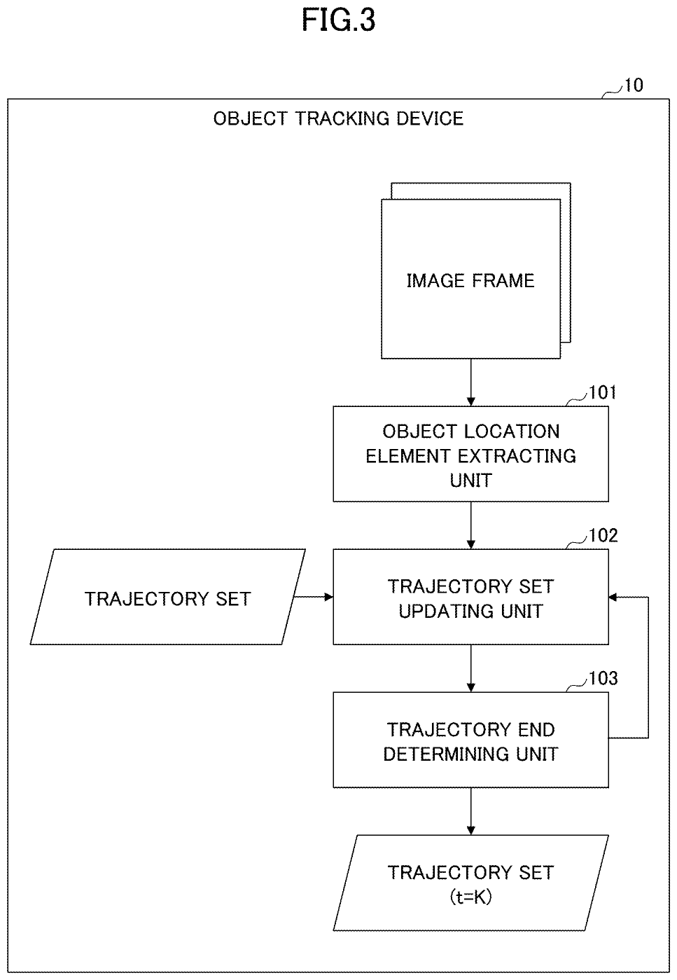

Next, the functional configuration of the object tracking device 10 according to the present embodiment will be described with reference to FIG. 3. FIG. 3 is a diagram showing an example functional configuration of the object tracking device 10 according to the present embodiment.

As shown in FIG. 3, the object tracking device 10 according to the present embodiment includes an object location element extracting unit 101, a trajectory set updating unit 102, and a trajectory end determining unit 103. These functional units are implemented by processes that one or more programs installed in the object tracking device 10 cause parallel processing hardware such as a GPU to execute.

The object location element extracting unit 101 extracts and outputs the primary point and secondary information of each individual object in an image frame received as input. In the present embodiment, for example, the center of the object field is the primary point, and the width and the height of the object field are the secondary information. However, this is simply an example, and, besides the center of the object field, the primary point may be, for example, the center of gravity of the object field, may be one randomly selected point in the object field, or may be the coordinates of the upper left vertex if the object field is a rectangle. Also, there need not be one primary point per object field, and multiple points may be extracted from one object field. Also, as for the secondary information, besides the width and height, information about the depth and the like may be included in the secondary information. Alternatively yet, in the event the object field is a rectangle, a set of the coordinates of four vertices, a set of the coordinates of mutually-diagonal two vertices, and so forth may be used as secondary information. Furthermore, a set of distances from the primary point in a plurality of predetermined directions may be used as secondary information. Note that one such distance may be, for example, the distance between the primary point and a point on the boundary of the object field.

Note that the object location element extracting unit 101 may first detect the object fields of detection-target objects from an image frame by using a given object detector, and then extract the primary points and secondary information from these object fields. If the object detector can extract the primary points and secondary information from an image frame, these primary points and secondary information may be extracted on an as-is basis. The object detector for outputting the primary points and secondary information can be configured in any way, and may be configured, for example, based on the method described in a reference document 1: “X. Zhou, D. Wang, and P. Krahenbuhl. Objects as points. In arXiv preprint arXiv: 1904.07850, 2019.”

Also, detection results (object fields, or primary points and secondary information) obtained by using an object detector are generally redundant (that is, multiple object fields (or primary points and secondary information) are obtained for the same object). In contrast to this, the process of eliminating the redundancy of object fields (or primary points and secondary information) based on primary points can be executed efficiently by using parallel processing hardware such as a GPU. Therefore, there is no need to transfer data between the CPU memory and the GPU memory.

Here, the process of eliminating the redundancy of object fields (or primary points and secondary information) based on primary points may employ a variety of methods. For example, in the event the primary points and secondary information are obtained by the method described in reference document 1 above, a maximum value pooling process may be used. That is, in the method described in above reference document 1, the primary points are output as a set of points with particularly high values on a heatmap. If the primary points are extracted based simply on how high their values are, the distances between these points are likely to be very small, and it is likely to output redundant primary points that all in effect capture the same object. So, in order to eliminate this redundancy, it is possible to perform maximum value pooling of a certain predetermined kernel size on a heat map, and extract the results as primary points. Note that the maximum value pooling process can be efficiently performed by using parallel processing hardware such as a GPU.

Using the primary points and secondary information extracted by the object location element extracting unit 101 from the image frame of the current time, the trajectory set updating unit 102 updates the set of trajectories obtained until the previous time. That is, the trajectory set updating unit 102 updates the trajectory set by associating the primary points and secondary information extracted from the image frame of the current time (or the object fields restored from these primary points and secondary information) with the trajectories included in the trajectory set, generates new trajectories, and so forth.

When the trajectory set updating unit 102 associates the primary points and secondary information extracted by the object location element extracting unit 101 with trajectories, the trajectory set updating unit 102 compares the distances between the primary points predicted from these trajectories and the extracted primary points. By doing so, the trajectory set updating unit 102 determines the primary points and secondary information to associate with the trajectories from among the extracted primary points and secondary information (or the object fields restored from these primary points and secondary information). Note that the calculation of distances between primary points and their comparison can be efficiently performed by using parallel processing hardware such as a GPU. Therefore, there is no need to transfer data between the CPU memory and the GPU memory.

Nevertheless, even if a primary point and secondary information (or an object field restored from these primary point and secondary information) are determined to be associated with a trajectory in the above process, the object that this trajectory indicates may be different from the object the primary point and secondary information indicate. Therefore, in order to realize more reliable object tracking, the trajectory set updating unit 102 takes advantage of characteristics that the size of each object is consistent between image frames, and that the primary point of an object that is captured large in a video is more likely to change its location dynamically, to determine whether or not to actually associate a trajectory with a primary point and secondary information.

The trajectory end determining unit 103 determines whether or not, among the trajectories included in the trajectory set, there are trajectories that are not updated at a later time.

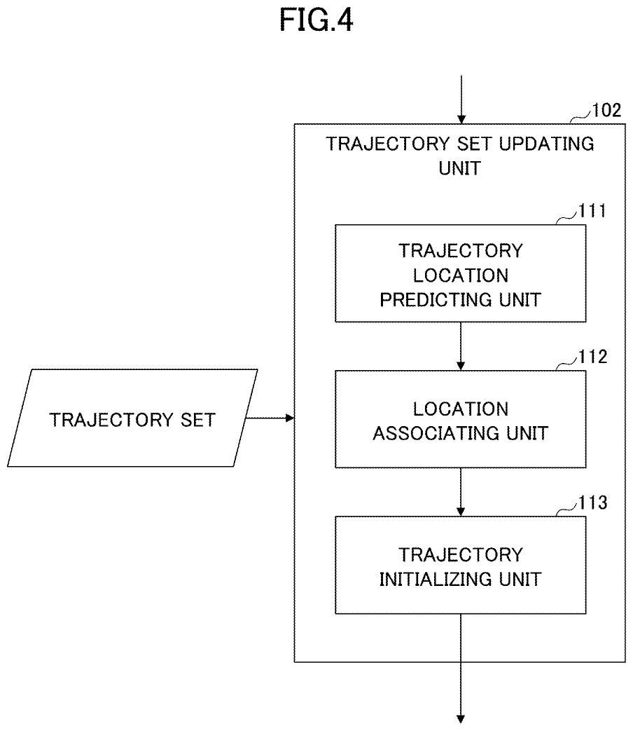

Here, a detailed functional configuration of the trajectory set updating unit 102 will be described with reference to FIG. 4. FIG. 4 is a diagram showing an example detailed functional configuration of the trajectory set updating unit 102 according to the present embodiment.

As shown in FIG. 4, the trajectory set updating unit 102 according to the present embodiment includes a trajectory location predicting unit 111, a location associating unit 112, and a trajectory initializing unit 113.

By using the trajectories obtained up to the previous time, the trajectory location predicting unit 111 builds motion models for the respective objects that these trajectories indicate. Then, based on these motion models, the primary points of objects in the current image frame (and the secondary information for restoring the object fields of the objects) are predicted.

Using the distances between the primary points extracted by the object location element extracting unit 101 and the primary points predicted by the trajectory location predicting unit 111, the location associating unit 112 determines the primary points and secondary information (or the object fields restored from these primary points and secondary information) to associate with the trajectories included in the trajectory set. Also, the location associating unit 112 first determines whether or not to actually associate the trajectories with the primary points and secondary information, and then associates the trajectories with the primary points and secondary information in accordance with the result of this determination. By this means, these primary points and secondary information are added to the trajectories, and the trajectory set is updated.

Here, the primary points and secondary information extracted by the object location element extracting unit 101 may include primary points and secondary information that are not associated with any of the trajectories included in the trajectory set built up to the previous time.

Among the primary points and secondary information extracted by the object location element extracting unit 101, the trajectory initializing unit 113 initializes the primary points and secondary information that are not associated with any of the trajectories included in the trajectory set built up to the previous time, as new trajectories. A new trajectory like this is composed only of a primary point and secondary information (or an object field restored from this primary point and secondary information) that are not associated with any of the trajectories included in the trajectory set built up to the previous time. Note that, if there are multiple primary points and secondary information that are not associated with any of the trajectories included in the trajectory set built up to the previous time, these multiple primary points and secondary information are all initialized as respective new trajectories.

<Object Tracking Process>

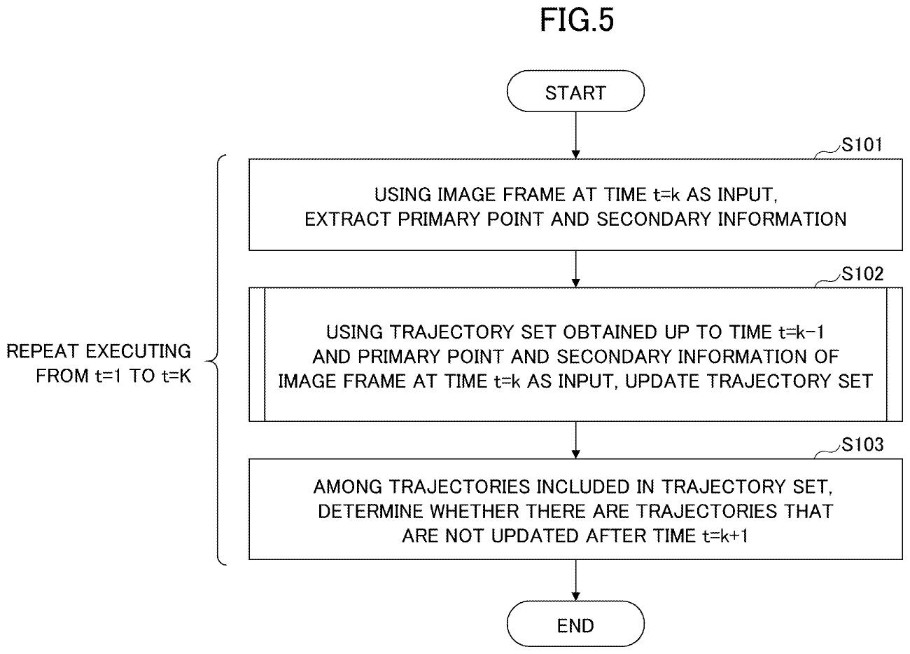

Next, the flow of the object tracking process executed by the object tracking device 10 according to the present embodiment will be described with reference to FIG. 5. FIG. 5 is a flowchart showing an example of the object tracking process according to the present embodiment. Steps S101 to S103 of this object tracking process are repeated from time t=1 to t=K. Hereinafter, a case in which time t is “k” will be described as an example. Note that the trajectory set is initialized to an empty set before the process of step S101 is started at time t=1 (or before the process of step S102 is started).

The object location element extracting unit 101 extracts and outputs the primary points and secondary information of each individual object in an image frame Iₖ (step S101).

Next, the trajectory set updating unit 102 receives, as input, the set of trajectories obtained by time t=k and the primary points and secondary information extracted in above step S101, and updates the trajectory set (step S102). Note that the process of this step will be described later in greater detail.

Then, the trajectory end determining unit 103 determines whether or not there are trajectories that are not updated after time t=k+1, in the trajectory set updated in step S102 (step S103). For example, if there is a trajectory to satisfy a predetermined condition among the trajectories included in the trajectory set, the trajectory end determining unit 103 may determine not to update this trajectory after time t=k+1. The condition for determining whether or not to update a trajectory after time t=k+1 may be, for example, that the trajectory's length (that is, the number of elements included in the trajectory) is less than or equal to a predetermined parameter D, among the trajectories that were not updated at time t=k−1. This is because, if a trajectory is associated with no primary point or secondary information at the previous time and its length is short, the object corresponding to this trajectory is unlikely to appear in the video later. Objects indicated by trajectories that satisfy the above condition typically include people, vehicles, and so forth, that pass in front of the camera.

Note that, for a trajectory that is not updated after time t=k+1, a flag to indicate that the trajectory is not going to be updated is set, for example. Showing this flag, the corresponding trajectory is excluded from updating targets after time t=k+1.

By repeating executing above steps S101 to S103 from time t=1 to time t=K, a set of trajectories indicating the tracks of respective objects in an input video are obtained. At this time, the object tracking device 10 according to the present embodiment causes parallel processing hardware such as a GPU to execute the processes of steps S101 to S103 described above. By this means, fast execution of the processes is made possible, and, furthermore, data transfer between the CPU memory and the GPU memory is reduced. Consequently, multi-object tracking with high throughput is realized. Note that each trajectory that is obtained after the process at time t=K is executed is output to an unspecified output destination (for example, a display device such as a display, another device connected via a communication network, a secondary memory device, etc.).

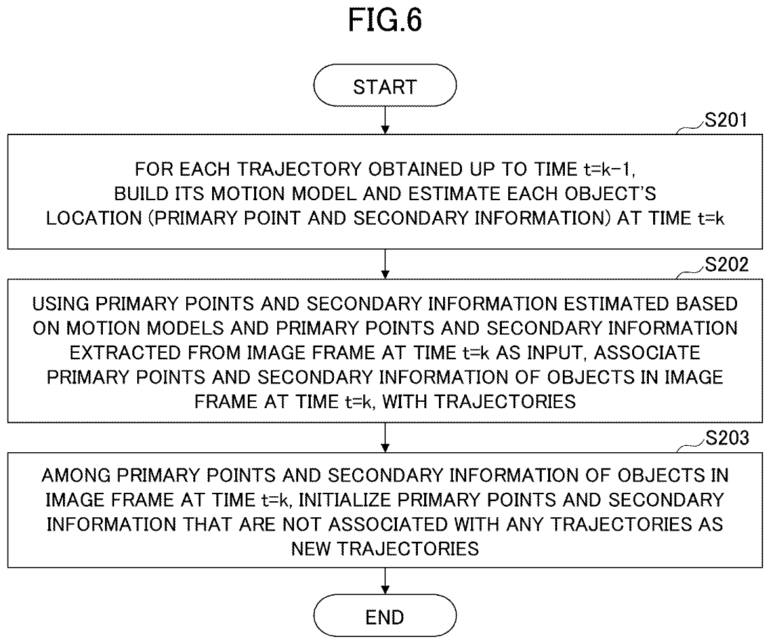

Here, the above-mentioned trajectory set updating process of step S102 will be described in detail with reference to FIG. 6. FIG. 6 is a flowchart showing an example of the trajectory set updating process according to the present embodiment.

First, using the trajectories obtained by time t=k−1, the trajectory location predicting unit 111 builds motion models of the objects indicated by these trajectories. Based on these motion models, the trajectory location predicting unit 111 predicts the locations (that is, the primary points, or the primary points and secondary information) of these objects in the image frame of time t=k (step S201). Here, the trajectory location predicting unit 111 may predict only the primary point of each object, or may predict both the primary point and secondary information of each object. As for the method of building motion models for predicting primary points (or primary points and secondary information), any method can be used, and, for example, the Kalman Filter that is described in a reference document 2 “T. Lucey, “Tutorial: The Kalman Filter” Internet URL: http://web.mit.edu/kirtley/kirtley/binlustuff/literature/control/Kalman%20filter.pdf” may be used. Note that, although the method of defining the locations of objects predicted by the Kalman Filter is not specified, for example, a primary point may be set as an object's location, or both a primary point and secondary information may be set as an object's location. In the event a primary point is set as an object's location, the primary point is predicted. In the event both a primary point and secondary information are set as an object's location, both the primary point and secondary information are predicted.

Hereinafter, assume that the trajectory location predicting unit 111 predicts the primary point and secondary information of each individual object in the image frame at time t=k. Note that, when the trajectory location predicting unit 111 predicts only the primary point of each object, it is possible to use that object's secondary information taken from the most recent time as secondary information predicted from the motion model, and use this in step S202, which will be described later (that is, the most recent secondary information among the secondary information included in the trajectory corresponding to that object may be used as the secondary information predicted from the motion model).

Next, using the primary points and secondary information extracted in step S101 of FIG. 5 (hereinafter also referred to as “extracted primary points” and “extracted secondary information”) and the primary points and secondary information predicted in above step S201 (hereinafter also referred to as “predicted primary points” and “predicted secondary information”), the location associating unit 112 associates the extracted primary points and the extracted secondary information with the trajectories included in the trajectory set (step S202). Here, letting P be a set of predicted primary points, letting S_{P} be a set of predicted secondary information corresponding to these predicted primary points, letting Q be a set of extracted primary points, and letting S_{Q} be a set of extracted secondary information corresponding to these extracted primary points, the location associating unit 112 associates the extracted primary points and the extracted secondary information with the trajectories included in the trajectory set through the following procedures 1 to 4. However, as mentioned earlier, not all extracted primary points and extracted secondary information are associated with trajectories, and there may be extracted primary points and extracted secondary information that are not associated with any trajectory.

Note that associating extracted primary points and extracted secondary information with trajectories means adding these extracted primary points and secondary information as elements of the trajectories at time t=k. By adding elements thus, trajectories are updated.

Procedure 1: The location associating unit 112 calculates the distances between all the predicted primary points included in P and all the extracted primary points included in Q by round-robin. In other words, the location associating unit 112 calculates the distances between the predicted primary points and the extracted primary points for all combinations of the predicted primary points and the extracted primary points. Note that any measure of distance can be used here, and, for example, the L2 norm or the like can be used.

Procedure 2: Next, the location associating unit 112 selects, for each predicted primary point included in P, the extracted primary point that is the closest in distance, among the extracted primary points included in Q, together with the distance. By this means, a predicted primary point, an extracted primary point, and a distance are grouped in one or more sets (generally, in multiple sets).

Procedure 3: Next, using S_{P} (or both S_{P} and S_{Q}), the location associating unit 112 calculates a distance threshold for each of the predicted primary points included in P.

Now, let pᵢ be each predicted primary point included in P, let (wᵢ, hᵢ) be the secondary information corresponding to predicted primary point pᵢ, let qⱼ be each extracted primary point included in Q, and let (wⱼ, hⱼ) be the secondary information corresponding to extracted primary point qⱼ. Given that, when calculating a distance threshold σᵢ for predicted primary point pᵢ by using S_{P} alone, the location associating unit 112 may calculate distance threshold ci according to following the equation (1), for example:

σᵢ=σ\sqrt{wᵢ²+hᵢ²} (1)

where σ is a pre-defined parameter.

On the other hand, when calculating distance threshold σᵢⱼ for predicted primary point pᵢ by using both S_{P} and S_{Q}, the location associating unit 112 may calculate distance threshold σᵢⱼ according to the following equation (2), for example:

σᵢⱼ=σ(\sqrt{wᵢ²+hᵢ²}+\sqrt{wⱼ²+hⱼ²})/2 (2)

Note that, when using both S_{P} and S_{Q}, |Q| distance thresholds σᵢⱼ are calculated for one predicted primary point pᵢ.

Procedure 4: Then, the location associating unit 112 associates the extracted primary points and the extracted secondary information with the trajectories corresponding to the predicted primary points, in ascending order of the distances obtained in above step 2. That is, in above step 2, while primary point pᵢ, extracted primary point qⱼ, and distance dᵢⱼ are grouped in multiple sets, the location associating unit 112 adds, in ascending order of distance dᵢⱼ, extracted primary point qⱼ included in one set and extracted secondary information (wⱼ, hⱼ) corresponding to this extracted primary point qⱼ, to the trajectory corresponding to predicted primary point pᵢ included in this set (that is, the trajectory used to build the predicted motion model for this predicted primary point pᵢ), as elements at time t=k.

However, at this time, if distance dᵢⱼ included in the set is greater than or equal to distance threshold σᵢ (or greater than or equal to σᵢⱼ), the location associating unit 112 does not associate extracted primary point qⱼ and extracted secondary information (wⱼ, hⱼ). Also, if the elements of time t=k are already added to the trajectory, the location associating unit 112 does not associate extracted primary point qⱼ and extracted secondary information (wⱼ, hⱼ).

Note that, although, in the present embodiment, distance threshold σᵢ (or σᵢⱼ) is first calculated in above procedure 3, and distance threshold σᵢ (or σᵢⱼ) and distance dᵢⱼ are compared in above procedure 4, to determine whether or not to actually update the trajectory, this calculation of the distance threshold and the comparison with the distance threshold may be omitted. However, more accurate multi-object tracking can be expected to be achieved by calculating the distance threshold and making a comparison with it.

Then, the trajectory initializing unit 113 generates new trajectories by initializing the extracted primary points and extracted secondary information that, among the extracted primary points and extracted secondary information, were not associated with any trajectory in step S202 (step S203). That is, the trajectory initializing unit 113 generates new trajectories including only extracted primary points and extracted secondary information that were not associated with any trajectory. Note that, if there are multiple extracted primary points and extracted secondary information that are not associated with any trajectory, new trajectories are generated that include, in a respective manner, these extracted primary points and extracted secondary information.

<Hardware Configuration of the Object Tracking Device 10>

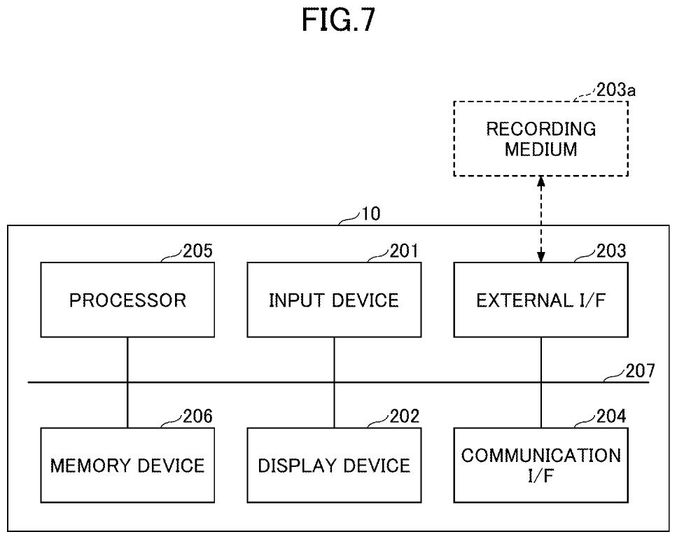

Finally, the hardware configuration of the object tracking device 10 according to the present embodiment will be described with reference to FIG. 7. FIG. 7 is a diagram showing an example hardware configuration of the object tracking device 10 according to the present embodiment.

As shown in FIG. 7, the object tracking device 10 according to the present embodiment is realized by a general computer or a computer system, and includes an input device 201, a display device 202, an external I/F 203, a communication I/F 204, a processor 205, and a memory device 206. Each of these pieces of hardware is communicably connected with each other via a bus 207.

The input device 201 is, for example, a keyboard, a mouse, a touch panel, and the like. The display device 202 is, for example, a display or the like. Note that the object tracking device 10 need not have at least one of the input device 201 and the display device 202.

The external I/F 203 is an interface with an external device such as a recording medium 203a. The object tracking device 10 can read and write in the recording medium 203a via the external I/F 203. The recording medium 203a may store, for example, one or more programs that implement the functional units (the object location element extracting unit 101, the trajectory set updating unit 102, and the trajectory end determining unit 103) of the object tracking device 10. Note that the recording medium 203a may be, for example, a CD (Compact Disc), a DVD (Digital Versatile Disk), an SD (Secure Digital) memory card, a USB (Universal Serial Bus) memory card, and the like.

The communication I/F 204 is an interface for connecting the object tracking device 10 to a communication network. Note that one or more programs that implement each functional unit of the object tracking device 10 may be acquired (downloaded) from a predetermined server device or the like via the communication I/F 204.

The processor 205 may be, for example, various arithmetic units such as a CPU and a GPU. Each functional unit of the object tracking device 10 is implemented, for example, by processes that one or more programs stored in the memory device 206 cause the processor 205 (particularly, a processor specialized for parallel computation such as a GPU) to execute.

The memory device 206 is, for example, various storage devices such as an HDD (Hard Disk Drive), an SSD (Solid State Drive), a RAM (Random Access Memory), a ROM (Read Only Memory), a flash memory, and the like.

The object tracking device 10 according to the present embodiment can realize the object tracking process described above by having the hardware configuration shown in FIG. 7. Note that the hardware configuration shown in FIG. 7 is an example, and the object tracking device 10 may have different hardware configurations as well. For example, the object tracking device 10 may have multiple processors 205, multiple memory devices 206, and so forth.

The present invention is by no means limited to the specifically disclosed embodiment described above, and various modifications, changes, combinations with known techniques, and so forth are possible without departing from the scope of the claims.

What is claimed is:

1. An object tracking device with parallel processing hardware, the object tracking device being configured to obtain trajectories that indicate tracks of target objects in an input video,
wherein the parallel processing hardware is configured to:
extract primary points and secondary information for restoring a field of a target object captured in an image frame at a time t included in the video;
select, from among the extracted primary points, a primary point having a distance that is closest to a predicted primary point of the target object predicted from trajectories obtained by a time t−1; and
when the distance is smaller than a first threshold determined from secondary information corresponding to the selected primary point, associate the selected primary point and the secondary information corresponding to the selected primary point, with a trajectory corresponding to the predicted primary point of the target object.

2. The object tracking device according to claim 1,
wherein the secondary information is a width w and a height h of the field of the target object, and
wherein the first threshold is determined to be σ×√(w²+h²) by using a predefined parameter σ and the secondary information w and h corresponding to the selected primary point.

3. The object tracking device according to claim 1,
wherein, when the distance is smaller than a second threshold determined from the secondary information corresponding to the selected primary point and predicted secondary information of the target object predicted from the trajectories obtained by time t−1, the parallel processing hardware associates the selected primary point and the secondary information corresponding to the primary point, with a trajectory corresponding to the predicted secondary information of the target object.

4. The object tracking device according to claim 3,
wherein the secondary information is a width w and a height h of the field of the target object,
wherein the predicted secondary information is a predicted width w′ and a predicted height h′ of the field of the target object, and
wherein the second threshold is calculated as σ×(√(w²+m²)+√(w′²+h′²))/2 by using a predefined parameter σ, the secondary information w and h corresponding to the selected primary point, and the predicted secondary information w′ and h′.

5. The object tracking device according to claim 1,
wherein, among the extracted primary points and secondary information, the parallel processing hardware generates primary points and secondary information that are not associated with trajectories as new trajectories.

6. The object tracking device according to claim 1,
wherein the primary point is any of, or at least one of:
a center of the field of the target object;
a center of gravity of the field of the target object; and
vertex coordinates of the field of the target object when the field is rectangular, and
wherein the secondary information is any of, or at least one of:
a width and a height of the field of the target object;
the width, the height, and a depth of the field of the target object; and
vertex coordinates of four vertices, or vertex coordinates of two mutually diagonal vertices, when the field of the target object is rectangular.

7. An object tracking method for obtaining trajectories that indicate tracks of target objects in an input video by using parallel processing hardware,
wherein the parallel processing hardware is configured to:
extract primary points and secondary information for restoring a field of a target object captured in an image frame at a time t included in the video;
select, from among the extracted primary points, a primary point having a distance that is closest to a predicted primary point of the target object predicted from trajectories obtained by a time t−1; and
when the distance is smaller than a first threshold determined from secondary information corresponding to the selected primary point, associate the selected primary point and the secondary information corresponding to the selected primary point, with a trajectory corresponding to the predicted primary point of the target object.

8. A non-transitory recording medium storing a program that causes a computer to function as the object tracking device according to claim 1.
